(19) United States
(12) Patent Application Publication
(10) Pub. No.: US 2012/0053151 A1
(43) Pub. Date: Mar. 1, 2012

(54) DIMETHOATE LOW VOC FORMULATIONS

(75) Inventor: Morten Pedersen, Lemvig (DK)

(73) Assignee: CHEMINOVA A/S, Lemvig (DK)

(21) Appl. No.: 13/318,218

(22) PCT Filed: Apr. 30, 2009
(86) PCT No.: PCT/DK09/50105

§ 371 Date: Oct. 31, 2011

(51) Int. Cl. A01N 57/12; A01P 7/04

(52) U.S. Cl. 514/119

(57) ABSTRACT

Liquid dimethoate formulations comprising a solvent chosen among liquids comprised of a compound having a ethylenglycol-propylenglycol co-polymeric chain as well as mixtures thereof. These solvents diminish the use of VOC solvents while still providing storage stable formulations.

### FIELD OF TECHNOLOGY

The present invention relates to Dimethoate formulations having no or low content of volatile organic compounds (VOC).

### BACKGROUND

Dimethoate, chemically termed as O,O-dimethyl-S-methyl carbamoyl methyl phosphorous dithioate, is a well-known compound for the control of insects. It is primarily used to control chewing and sucking insects attacking agricultural and plantation crops, and works both systemically and by contact.

When using Dimethoate, a major disadvantage is that the compound is thermally unstable and, at temperatures above approximately 50° C., it may decompose uncontrollably and, at worst, result in explosions. Even at lower temperatures, Dimethoate will decompose and lead to its activity dropping. It is essential to be able to stabilize Dimethoate formulations so as to withstand even long-term storage without loss of activity, particularly in warm climatic surroundings. On standing, Dimethoate will degrade into the corresponding S-methyl isomer (isodimethoate). The S-methyl isomer has proven toxic to mammals and, hence, it is undesirable in the final formulation.

Liquid formulations comprising Dimethoate and organic solvents are readily available and are by example described in International Patent application WO-2002/089574-A1.

The use of VOC, including their use in agrochemical formulations, is believed to contribute to ozone formation, and thus there is a need to reduce emissions from VOC's to the surroundings. However, commercially available concentrated liquid formulations of Dimethoate often makes use of high amounts of Volatile Organic Compounds (VOC) and it is highly desirable from an environmental point of view to reduce and preferably to eliminate the use of such compounds in Dimethoate formulations.

On the other hand is has proven difficult to replace such solvent, that by nature usually contribute significantly to the stability of the Dimethoate, without risking an increasing formation of highly undesired degradation products such as isodimethoate and omethoate upon storage and in particular on long term storage under elevated temperature conditions. In addition, the solvents used to replace the VOC solvents should be so selected as not to cause a risk to the environment or to those handling the final formulations both during preparation as well as use thereof e.g. for controlling insects. For these reasons acetone by example, which has been granted VOC-exempt status even though it's a volatile compound but does not contribute to ozone formation, is an excellent solvent for use in liquid Dimethoate formulations, but is undesirable to use on its own due to its extremely flammable nature.

It has now been found that VOC solvents may be replaced entirely or at least in part with certain polymeric compounds as solvents of low volatility without compromising the stability of the Dimethoate especially on storage and still provide formulations with high insecticidal activity.

### DESCRIPTION OF THE INVENTION

The liquid formulations according to the invention comprise
a) Dimethoate and
b) a solvent chosen among liquids comprised of a compound having a ethylenglycol-propylenglycol co-polymeric chain as well as mixtures thereof.

For the purpose of this invention, the solvent chosen among liquids comprised of a compound having a ethylenglycol-propylenglycol co-polymeric chain as well as mixtures thereof are suitable in the liquid state at ambient temperature.

Preferably, the solvent compound is in a liquid state at a temperature of about 20° C. and preferably remains in the liquid state in the temperature interval of 0-30° C. and more preferably in the interval of −10-50° C.

The concentrated formulations may contain up to 80% by weight Dimethoate based on the weight of the formulation, preferably, between 10 and 70% by weight and, more preferably, between 20 and 60% by weight, even more preferably 25-50% and most preferably between 30-45%.

The solvent b) chosen among liquids comprised of a compound having a ethylenglycol-propylenglycol co-polymeric chain as well as mixtures thereof may be selected among random co-polymer compounds comprised of ethylene oxide (EO) and propylene oxide (PO) units or may be selected among non-random polymer compounds (EO/PO block co-polymer) comprised of blocks of ethylene oxide (EO) and propylene oxide (PO) units and in either case such compound(s) optionally being end-capped. Combinations of both random and non-random EO/PO co-polymers may also be used as solvent. Whereas a random copolymer of EO and PO units can be synthesized directly from an appropriate mixture of ethylene and propylene oxide, and thus the different oxide molecules are added to the polymer chain in a random sequence, the non-random block copolymers are synthesized sequentially. First, a central block is commonly polymerized from one type of alkylen oxide (e.g. PO), then one or more outer blocks are added to the ends in a second polymerization step using another alkylen oxide (e.g. EO). Poloxamers are linear A-B-A triblock copolymers of EO and PO having the general formula (EO)ₓ(PO)_{y}(EO)ₓ, where x, y are the average number of EO and PO monomer units in the block. Meroxapols are linear triblock copolymers similar to poloxamers but with a reversed (B-A-B) structure and hence the general formula (PO)_{y}(EO)ₓ(PO)_{y}.

The EO/PO co-polymers or their end-capped derivatives, which are to be used, in accordance with the invention, as component (b), are known per se. Preferred in accordance with the invention are the optionally end-capped ethylene oxide/propylene oxide block copolymers (non-random type) selected among polymers of the formula (Ia), (Ib), (Ic), (Id).

R₁O—(C₂H₄O)ₚ—(C₃H₆O)_{q}—R₂ (Ia)

R₁O—(C₃H₆O)ₚ—(C₂H₄O)_{q}—R₂ (Ib)

R₁O—(C₂H₄O)ₚ—(C₃H₆O)_{q}—(C₂H₄O)ᵣ—R₂ (Ic)

R₁O—(C₃H₆O)ₚ—(C₂H₄O)_{q}—(C₃H₆O)ᵣ—R₂ (Id)

where p, q, r independently of one another represent an integer of 2 or more and R₁, R₂ independently of one another are hydrogen, C₁-C₄ alkyl, C₁-C₄ alkyl-CO, or derivatives thereof suitable for end-capping.

To increase the non-volatile nature of the solvent, a solvent is generally used having p, q, r values selected independently of one another among integers of 5 or more, such as 10 more. To obtain a suitable liquid at ambient temperatures it is generally desired to select the values p, q, r independently of each other among integers of 300 or less. Preferably, p, q, r independently of one another represent an integer of 200 or less, such as 150 or less.

Suitably, p, q, r independently of one another correspond to a value in the range of from 2 to 300, preferably from 5 to 200 and in particular from 10 to 150.

The end-capping groups R₁ and R₂ may in particular, when present, independently of one another be selected among methyl, t-butyl and acetyl groups. The specific choice of end-capping group is of less importance for the formulation. Thus, the present invention is intended to cover any end-capping group suitable for the purpose, i.e. the formation of a stable liquid formulation.

The random co-polymers resembles the block co-polymers of structure (Ia)/(Ib) with the difference being the random distribution of the EO and PO monomer units.

Preferably, the weight-average molecular weight (g/mol) of both the random co-polymers and the block co-polymers to be used in accordance with the invention is at least 500, preferably at least 1000 and in particular at least 1800. As a rule, co-polymers are used whose weight-average molecular weight is less than 25000 preferably less than 15000 and in particular less than 10000. Preferred ranges of weight-average molecular weights are 500 to 15000, preferably 1000 to 10000, in particular 1000 to 8000. Also, the co-polymers have a preferred range of EO units from 10 to 90% by weight and a most preferred range of 50 to 85% by weight.

A large number of representatives of such liquid block co-polymers are readily commercially available. EO/PO block copolymers mentioned by way of example in this context are those which are available from BASF under the tradename Pluronic e.g Pluronic PE 6100 and Pluronic PE 6200, Antarox L-64 available from Rhodia, available under the tradename Synperonic from Croda such as Synperonic PE L/31, Synperonic PE L/64, Synperonic PE L/44, and liquid random co-polymers available from BASF under the tradename Pluriol e.g. Pluriol A 2000 PE, Pluriol A 4000 PE plus and Pluriol A2600 PE plus; or available from Cognis under the tradename Aqnique, e.g. Agnique ED 0001 or from Cognis under the tradename Breox e.g. Breox 50A 50, Breox 50A 140 and Breox 50 A 225.

The EO/PO block co-polymers of the formula (Ia), (Ib) (Ic) are preferred—as well as the random co-polymers.

To obtain the desired stabilizing effect of the solvent it generally needs to be present in a certain amount relative to Dimethoate in the formulation. According to a certain aspect of the invention the ratio of solvent b) to Dimethoate is 1 part of solvent b) to 4 parts or less of Dimethoate. Preferably, the ratio of solvent b) to Dimethoate is 1 part of solvent b) to 2 parts or less of Dimethoate. More preferably, the formulation contains per 1 part of solvent, 1.5 parts or less of Dimethoate, such as 1.2 parts or less of Dimethoate, and most preferred 1.1 parts or less of Dimethoate.

Above a certain level the amount of solvent does not further stabilizes the formulation. Therefore, it is in general desired to use a ratio of solvent b) to Dimethoate, which is 1 part or more of solvent b) to 5 parts of Dimethoate. In preferred aspects of the invention the ratio of solvent b) to Dimethoate is 1 part or more of solvent b) to 4 parts of Dimethoate. Still more preferred, the ratio of solvent b) to Dimethoate is 1 part or more of solvent b) to 3 parts of Dimethoate, such as 2.5 parts of Dimethoate, and most preferred 2 parts of Dimethoate.

The ratio between Dimethoate and solvent b) is generally chosen between 4:1-1:5, preferably between 2:1-1:4, more preferably between, 1.5:1-1:3, even more preferably between 1.2:1-1:2.5 and most preferably between 1.1:1-1:2. In a preferred embodiment the amount of solvent b) is in excess of the Dimethoate. e.g. the ratio between Dimethoate and solvent b) is between 1-1:5, preferably between 1-1:4 and more preferably between, 1-1:3, even more preferably between 1-1:2.5 and most preferably between 1-1:2.

No lower limit as to the amount of solvent b) has been established. To increase the stabilizing effect it is generally useful to apply an amount of solvent b) which is higher than 20% by weight, based on the total weight of the formulation. A more pronounced stabilizing effect is obtained when the amount of solvent b) is higher than 30% by weight, such as higher than 35% by weight, based on the total weight of the formulation. When amounts herein are based on the total weight of the formulation, it is to understood, that the concentrate of the formulation is meant, i.e. the formulation does not include any conventional diluent usually used to dilute the formulation prior to application.

To avoid an unnecessary dilution of the formulation with out obtaining a further stabilizing effect the amount of solvent b) is generally less than 95% by weight, such as less than 85% by weight, based on the total weight of the formulation. In a certain embodiment of the invention, the amount of solvent b) is less than 75% by weight, based on the total weight of the formulation. Most preferably, the amount of solvent b) is less than 55% by weight, based on the total weight of the formulation.

In a preferred embodiment the amount of solvent b) is between 20-95% by weight, preferably between 25-85% by weight, more preferably 30-75% by weight, and most preferably 35-55% by weight.

Although it is desirable to prepare formulations that does not comprise any other solvent, stability of the Dimethoate is in certain embodiments of the invention improved by including one or more co-solvents as component c) in the formulations e.g. due to the nature of the solvent b). Examples of such co-solvents include mineral oils, aliphatic, cyclic, and aromatic carbon hydride compounds, e.g. xylene, paraffin, tetra-hydro napthalene, alkylated napthalenes or derivative compounds thereof, alkylated benzenes as well as derivative compounds thereof, aliphatic, cyclic, and aromatic alcohols, gamma-butyrolactone, cyclohexanone or highly polar solvents. A preferred co-solvent is cyclohexanone.

If a co-solvent c) is present, the solvent b) is generally present in excess of the co-solvent, i.e. the ratio of solvent b) to the co-solvent is 1 part of solvent b) to 1.0 part or less of the co-solvent. In a preferred aspect of the invention, the ratio of solvent b) to the co-solvent is 1 part of solvent b) to 0.8 parts or less, such as 0.7 parts or less of the co-solvent. Most preferably, the ratio of solvent b) to the co-solvent is 1 part of solvent b) to 0.6 parts or less of the co-solvent.

Even though a minimum level of the amount of co-solvent for further stabilization of Dimethoate has not been detected, it is generally desired to use a ratio of solvent b) to co-solvent which is 1 part of the solvent b) to 0.05 parts or more, such as 0.15 parts or more of co-solvent. In a most preferred aspect of the invention, the ratio of solvent b) to co-solvent is 1 part of the solvent b) to 0.30 parts or more of co-solvent.

In general, the weight ratio between solvent b) and solvent c) is between 1:1.0-1:0.05, preferably between 1:0.8-1:0.1, more preferably between 1:0.7-1:0.15 and most preferably between 1:0.6-1:0.3.

The formulation, including those that do not comprise a co-solvent, may also contain, as an optional auxiliary (d), one or more surfactants. Surfactants are, for example, non-aromatic-based surfactants, based for example on heterocycles, olefins, aliphatics or cycloaliphatics, examples being surface-active, mono- or poly-alkyl-substituted and subsequently derivatized, e.g., alkoxylated, sulfated, sulfonated or phosphated, pyridine, pyrimidine, triazine, pyrrole, pyrrolidine, furan, thiophene, benzoxazole, benzothiazole, and triazole compounds, and/or aromatic-based surfactants, examples being mono-, or poly-alkyl-substituted and subsequently derivatized, e.g., alkoxylated, sulfated, sulfonated or phosphated benzenes or phenols. Such surface active compounds are generally known and readily available on a commercial scale.

Further optionally auxiliaries (e) which may be included in the liquid concentrated formulations as described herein are pH-adjusters, thickeners, antifreeze agents, preservatives, antifoaming and defoamer agents, spreading agents, stickers, UV-protectants, stabilizers, and one or more additional insecticides different from Dimethoate. Such auxiliaries are generally known within the art of formulation chemistry, and although a specific ingredient is classified as falling within one category, it may well serve the purpose of any of the others.

The pH adjusters include both acids and bases of the organic or inorganic type. Suitable pH adjusters include organic acids and alkali metal compounds. The organic acids include those such as citric, malic, adipic, cinnamic, fumaric, lactic, maleic, succinic, and tartaric acid, and the mono-, di-, or tribasic salts of these acids are suitable organic acid salts. Suitable salts of these acids are the soluble or meltable salts and include those salts in which one or more acidic protons are replaced with a cation such as sodium, potassium, calcium, magnesium, and ammonium. Alkali metal compounds include hydroxides of alkali metals such as sodium hydroxide and potassium hydroxide, carbonates of alkali metals such as sodium carbonate and potassium carbonate, hydrogencarbonates of alkali metals such as sodium hydrogencarbonate and alkali metal phosphates such as sodium phosphate.

Thickeners and film-forming agents include starches, gums, casein and gelatine, polyvinyl pyrrolidones, polyethylene and polypropylene glycols, polyacrylates, polyacrylamides, polyethyleneimines, polyvinyl alcohols, polyvinyl acetates, and methyl-, hydroxyethyl- and hydroxypropylcelluloses and derivatives thereof. Examples of the antifreezing agent include ethylene glycol, diethylene glycol, propylene glycol and the like.

Typical preservatives include methyl and propyl parahydroxybenzoate, 2-bromo-2-nitro-propane-1,3-diol, sodium benzoate, formaldehyde, glutaraldehyde, O-phenylphenol, benzisothiazolinones, 5-chloro-2-methyl-4-isothiazolin-3-one, pentachlorophenol, 2-4-dichlorobenzylalcohol and sorbic acid and derivatives thereof.

Preferred anti-foaming and defoamer agents are silicone based compounds e.g. polyalkylsiloxanes.

If a stabilizer is included is may preferably be selected among anhydrides e.g. acetic acid anhydride and maleic acid anhydride, propionic acid anhydride and butyric acid anhydride and in particular acetic acid anhydride and maleic acid anhydride. The formulations may preferably comprise 0.1 to 20 parts by weight stabilizer, calculated on the basis of 100 parts by weight Dimethoate. The use of a stabilizer in a quantity below 0.1 parts by weight may be appropriate in certain formulations. However, usually a concentration above 0.1 parts by weight stabilizer is preferred to ensure a sufficiently stabilized effect. More preferably, formulations comprising 1 to 15 parts by weight stabilizer and, most preferably, 2 to 10 parts by weight calculated on the basis of 100 parts by weight Dimethoate.

The optional additional insecticide (including acaricides and nematicides) may also be added to the formulation provided that the additional insecticide does not interfere in a negative way with the stability of the final formulation. The presence of the optional additional insecticide may also enhance the activity of the Dimethoate. An additional insecticide may be utilized if broadening of the spectrum of control or preventing the build-up of resistance is desired. Suitable examples of such additional active compounds are: abamectin, acephate, acetamiprid, acrinathrin, alanycarb, albendazole, aldicarb, alphamethrin, amitraz, azadirachtin, azinphos, azocyclotin, Bacillus thuringiensis, bendiocarb, benfuracarb, bensultap, bephenium, betacyfluthrin, bifenazate, bifenthrin, bistrifluoron, BPMC, brofenprox, bromophos, brotianide, bufencarb, buprofezin, butamisole, butocarboxin, butylpyridaben, cadusafos, cambendazole, carbaryl, carbofuran, carbophenothion, carbosulfan, cartap, chloethocarb, chloroethoxyfos, chlorfenapyr, chlorofenvinphos, chlorofluazuron, chloromephos, chlorpyrifos, chromafenozide, cis-resmethrin, clocythrin, clofentezine, clorsulon, closantel, clothianidin, cyanophos, cycloprothrin, cyfluthrin, cyhalothrin, cyhexatin, cy-permethrin, cyromazine, deltamethrin, demeton, diamphenethide, dibromosalan, dichlorophen, difenthiuron, diazinon, dichlofenthion, dichlorvos, dicliphos, di-crotophos, diethion, diethylcarbamazine, diflubenzuron, dimethylvinphos, dinotefuran, dioxathion, disulfoton, edifenphos, emamectin(-benzoate) epsiprantel, esfenvalerate, ethiofencarb, ethion, ethiprole, ethofenprox, ethoprophos, etoxazole, etrimphos, febantel, fenamiphos, fenbendazole, fenzaquin, fenbutatin oxide, fenitrothion, fenobucarb, fenothiocarb, fenoxycarb, fenpropathrin, fenpyrad, fenpyroximate, fenthion, fenvalerate, fipronil, flonicamid, fluazuron, flubendazole, flucycloxuron, flucythrinate, flufenoxuron, flufenprox, fluvalinate, fonophos, formothion, fosthiazate, fubfenprox, furathiocarb, gamma-cyhalothrin, haloxon, heptenophos, hexaflumuron, hexachlorophene, hexythiazox, imidacloprid, indoxacarb, iprobenfos, isazophos, isofenphos, isoprocarb, isoxathion, ivermectin, lambda-cyhalothrin, levamisole, lufenuron, malathion, mebendazole, mecarbam, mevinphos, mesulfenphos, metaldehyde, methacrifos, methamidophos, methidathion, methiocarb, methomyl, methoxyfenozide, methyridine, metolcarb, milbemectin, monocrotophos, morantel, naled, netobimin, niclopholan, niclosamide, nitenpyram, nitroxynil, omethoate, oxamyl, oxfendazole, oxibendazole, oxyclozanide, oxydemethon M, oxydeprofos, parathion A, parathion M, parbendazol, permethrin, phenothiazine, phenthoate, phorate, phosalone, phosmet, phosphamidon, phoxim, pirimicarb, pirimiphos, praziquantel, profenofos, promecarb, propaphos, propoxur, prothiofos, prothoate, pymetrozin, pyrachlophos, pyrantel, pyridaphenthion, pyresmethrin, pyrethrum, pyridaben, pyrimidifen, pyriproxifen, quinalphos, rafoxanide, rynaxypyr, salithion, sebufos, silafluofen, spinosad, spinetoram, spirodiclofen, spiromesifen, spirotetratmat, sulfotep, sulprofos, tebufenozid, tebufenpyrad, tebupirimiphos, teflubenzuron, tefluthrin, temephos, terbam, terbufos, tetra-chlorvinphos, tetramisole, thenium, thiabendazole, thiacloprid, thiafenox, thia-methoxam thiodicarb, thiofanox, thiomethon, thionazin, thiophanate, thuringiensin, tralomethrin, triarathen, triazophos, triazuron, trichlorfon, triclabendazole, triflumuron, trimethacarb, vamidothion, XMC, xylylcarb, zetamethrin.

Further, inclusion of other known active compounds, such as herbicides, fungicides, fertilisers or growth regulators, is also possible.

Common for all ingredients used according to the invention is that they be selected as not to cause any undesirable side effects when used in plant or seed protection, e.g. to induce phytotoxicity.

The concentrated liquid formulations according to the invention are prepared in a conventional manner, by mixing all ingredients, preferably under stirring, and optionally prepared under elevated temperatures to ease formation of a homogeneous composition.

The formulations as described herein may be used in a method for the control of undesirable insects including protection of crops against such insects, said method comprise e.g. applying the formulations preferably in diluted form (e.g. aqueous diluted form), to the insects or to plants, plant seeds, soil, surfaces and the like infested with insects or likely to be occupied by insects. The formulations according to the invention are applicable for the control of quite a number of insects, primarily sucking and chewing insects, in areas grown with agricultural and plantation crops in particular, but may advantageously also be used in other places infected with undesired insects, e.g. areas where insects live or their eggs hatch outdoor as well as indoor. Use of the formulations as described herein comprises delivering to the target a formulation in an insecticidal effective and adequate amount. An effective amount is an amount sufficient to provide adequate insect control, i.e. an amount that has the ability to combat the harmful insects sufficiently to cause a measurable reduction in the exposed insect population. An adequate amount cannot generally be defined, since it depends upon, e.g., the harmful insects to be controlled, method of application, the type or size of plant or seed to be protected, and climate condition at time of application. Suitably the Dimethoate formulations are diluted for crop protection as to deliver an amount between 50-2000 grams pr. hectare, preferably 100-1500 g/ha, more preferably 200-1000 g/ha. and even more preferably between 300-800 g/ha.

Crops the formulations may be applied to include: rice, almonds, citrus, nectarines, cherries, apples, celery, grapes, broccoli, cereals, brussels sprouts, celery, lentils, mushroom, strawberries, onions, cabbage, cauliflower, cotton, persimmon, cucumbers, lettuce, cucurbits, melons, avocado, figs, peaches, pears, apricots, potatoes, beans, soybeans, beets, tomato, berries, mint, squash, eggplant, pepper, radish, spinach, sweet corn, grasses, clover, and ornamentals and forests; The undesirable insects include rice water weevil, green rice leafhopper, brown planthopper, white-backed planthopper, grass leaf roller, rice stem borer, smaller brown planthopper, mosquito, navel orangeworm, peach twig borer, apple aphid, cereal aphid, redbanded leafroller, obliquebanded leafroller, plum curculio, white apple leafhopper, spotted tentiform leafminer, tarnished plant bug, vegetable leafminer, cabbage looper, imported cabbageworm, granulate cutworm, black cutworm, fall armyworm, beet armyworm, diamondback moth, bollworm (corn earworm), tobacco budworm, pink bollworm, lygus bugs, cotton leaf perforator, boll weevil, cotton fleahopper, saltmarsh caterpillar, whitefly, cotton aphid, oriental fruit moth, green fruitworm, lesser peachtree borer, rose chafer, pear psylla, codling moth, green fruitworm, Colorado potato beetle, potato leafhopper, aster leafhopper, potato flea beetle, potato aphid, potato tuberworm, potato psyllid, green cloverworm, Mexican bean beetle, bean leaf beetle, soybean looper, velvetbean caterpillar, leafhoppers, cutworm complex, European corn borer, Southern armyworm, gypsy moth, western spruce budworm, eastern spruce budworm, tussock moth, tent caterpillar, fall webworm, canker worm, and pine sawfly. Within the scope of this invention such crops further comprise those that are resistant, either by transgenic means or selected by classical means, to pesticidal active ingredients and/or those that are resistant to certain pests, for example Bacillus thuringiensis (Bt) pest-resistant crops.

The formulations according to the invention show bioefficacy comparable to that of conventional Dimethoate formulations but at the same time avoids the use of large amounts of hazardous and/or volatile organic solvents and as such are more environmental and user friendly with an improved toxicological profile such as reduced eye and skin irritation. Besides being chemically stable for a prolonged period of time on storage, the formulations are easily degraded in soil upon application which is highly desirable from an environmental perspective. The formulations have for a crop protection purpose an excellent crop-safety profile, i.e. they can be applied without causing phytotoxic damage on crops. Low phytotoxicity is of importance and it is of special importance when spraying on susceptible crops (both the plant itself and in particular fruits thereof).

While concentrated formulations are preferred as commercially available goods, the end consumer uses, as a rule, dilute formulations. These formulations may be diluted to concentrations down to between 0.0001 and 4% of active ingredient (a.i.) by weight of total solution. In general the a.i. concentrations are between 0.001 and 3% by weight, preferably 0.005 to 2% by weight.

The invention is illustrated by the following examples:

### EXAMPLE 1

A composition consisting of 38% w/w Dimethoate technical, minimum 96.0% w/w purity, 57% w/w Synperonic PE L/31, EO/PO block co-polymer, average molecular weight 1100, and 5% acetic acid anhydride was prepared. Dimethoate was easily dissolved in the Synperonic PE/L31 given a low-viscosity solution. The Dimethoate concentration in the composition was 37.6% w/w according to a validated GC method. With regard to chemical stability of dimethoate and formation of the degradation products omethoate and isodimethoate the composition described in the present example fulfilled the requirements in the FAO specification for Dimethoate EC formulation (August 2005). A thermo-gravimetric analysis carried out at 115° C. showed that Synperonic PE/L31 did not evaporate at this elevated temperature.

### EXAMPLE 2

A composition consisting of 40.0% w/w Dimethoate technical, minimum 96.0% w/w purity, 41.0% w/w Pluronic PE 6100, EO/PO block co-polymer, average molecular weight 2000, and 19% w/w acetic acid anhydride was prepared. The composition was a low-viscosity solution of Dimethoate. Dimethoate was easily dissolved in the Pluronic PE 6100. The concentration of Dimethoate in the composition was 38.8% w/w according to a validated GC method.

At an accelerated stability test, i.e. storage for 14 days at 54° C., the Dimethoate concentration dropped slightly from 38.8% w/w to 35.9% w/w. The isodimethoate concentration in the composition before and after the accelerated stability test was <0.01% w/w and 0.03% w/w, respectively. Regarding the degradation product, omethoate, the concentration both before and after storage was below 0.02% w/w. The present stability figures for Dimethoate, isodimethoate and omethoate fulfilled the requirements for the Dimethoate stability and the limits for isodimethoate and omethoate formation in the FAO specification for Dimethoate EC formulation (August, 2005).

The composition described was easily diluted to relevant spraying concentrations. Due to the high molecular weight and the high polarity of Pluronic PE 6100 this compound does not evaporate after the composition has been sprayed. A thermo-gravimetric analysis carried out at 115° C. showed that Pluronic PE 6100 did not evaporate at this elevated temperature.

### EXAMPLE 3

The compositions shown in table 1 were produced. The compositions were low-viscosity solutions of Dimethoate technical in a random copolymer of EO/PO, molecular weight 2500*. According to a 1H quantitative NMR analysis, the weight based ratio between ethylene oxide and propylene oxide units were 88:12.

TABLE 1

| | Composition | | |
|---|---|---|---|
| | I | II | III |
| Dimethoate tech. | 25% w/w | 30% w/w | 35% w/w |
| Poly(ethylene glycol-random- | 71% w/w | 66% w/w | 61% w/w |
| propylene glycol copolymer* | | | |
| Acetic acid anhydride | 4% w/w | 4% w/w | 4% w/w |
| Dimethoate conc. before and | 25.3% w/w | 29.8% w/w | 34.7% w/w |
| after storage for 14 days at | 24.6% w/w | 28.7% w/w | 33.3% w/w |
| 54° C. | | | |
| Isodimethoate conc. | 0.019% w/w | 0.030% w/w | 0.046% w/w |
| before and after storage for 14 | 0.28% w/w | 0.44% w/w | 0.64% w/w |
| days at 54° C. | | | |
| Omethoate conc. before and | <0.02% w/w | <0.02% w/w | <0.02% w/w |
| after storage for 14 days at | <0.02% w/w | <0.02% w/w | <0.02% w/w |
| 54° C. | | | |
| Cold stable down to | 5° C. | 5° C. | — |

*Sigma-Aldrich Product no. 438197

The three compositions mentioned in table 1 and a commercial Dimethoate 400 g/l EC were tested on Dysdercus cingulatus nymphs in the 5^{th} development stage. The three compositions and the EC were sprayed at cotton leaves at different concentrations and the nymphs were placed on the leaves in petri dishes for 72 h. The mortality was recorded. The mortality results are tabulated below.

TABLE 2

| | Composition | | | |
|---|---|---|---|---|
| | I | II | III | |
| Dimethoate tech. | 25% w/w | 30% w/w | 35% w/w | Commercial |
| Poly(ethylene glycol- | 71% w/w | 66% w/w | 61% w/w | Dimethoate |
| random-propylene | | | | 400 g/l |
| glycol copolymer* | | | | EC |
| Acetic acid anhydride | 4% w/w | 4% w/w | 4% w/w | |
| % Mortality of | | | | |
| Dysdercus cingulatus | | | | |
| nymphs | | | | |
| At 10 g ai/ha | 64 | 65 | 60 | 15 |
| At 20 g ai/ha | 94 | 89 | 91 | 59 |

*Sigma-Aldrich Product no. 438197

Compared to the commercial Dimethoate 400 g/l EC the compositions containing the random copolymer of ethylene oxide/propylene oxide, molecular weight 2500, had superior activity against Dysdercus cingulatus nymphs, table 2.

### EXAMPLE 4

A composition consisting of 32% w/w technical Dimethoate, minimum purity 96% w/w, 4% maleic acid anhydride, Pluronic PE 6100 45% w/w and 19% w/w cyclohexanone was prepared. The concentration of Dimethoate in the composition before and after storage for 14 days at 54° C. was 31.1% w/w and 30.4% w/w, respectively. The isodimethoate concentration in the composition before and after storage for 14 days at 54° C. was <0.01% w/w and 0.17% w/w.

### EXAMPLE 5

A composition consisting of 29% w/w technical Dimethoate, minimum purity 96% w/w, 4% w/w acetic acid anhydride, 48% w/w Pluronic PE 6200 and 19% w/w cyclohexanone was prepared. The composition was stable down to at least 5° C. That is precipitate or crystals were not formed even after the composition was seeded with Dimethoate crystals at 5° C. The composition was easily diluted to spraying concentration and the spraying liquid was clear and transparent. According to a validated GC method, the Dimethoate content before and after storage for 14 days at 54° C. was 28.5% w/w and 27.7% w/w, respectively. The concentration of isodimethoate before storage for 14 days at 54° C. was 0.025% w/w and after storage 0.20% w/w. Both before and after storage the concentration of omethoate was below 0.02% w/w.

On nymphs of Dysdercus cingulatus, 5^{th} development stage, the present composition was as active per g a.i. as a commercial Dimethoate 400 g/l EC formulation. Likewise the present composition was as active as a commercial Dimethoate 400 g/l EC on Musca domestica.

Regarding phytotoxicity on cucumber and tomato plants the present Dimethoate composition containing Pluronic PE 6200 was on par with the commercial Dimethoate 400 g/l EC mentioned above

### EXAMPLE 6

Compositions consisting of 32% w/w technical Dimethoate, minimum purity 96% w/w, 4% w/w acetic acid anhydride, 45% w/w Antarox L-64, EO/PO block copolymer, average molecular weight ca. 2900, and 19% w/w gamma-butyrolactone or 19% w/w cyclohexanon were prepared. According to a validated GC method the Dimethoate content was 31% w/w in both compositions. Both compositions were cold stable down to at least 5° C., i.e., crystals or precipitate did not form after seeding with Dimethoate crystals at 5° C.

For both compositions less than 3.8% w/w of the initial content of Dimethoate was degraded after storage at 54° C. for 14 days.

The compositions were low-viscosity solutions of Dimethoate and the compositions were easy to dilute in water to spraying concentrations.

### EXAMPLE 7

The Dimethoate composition based on Antarox L-64 and cyclohexanone and described in example 6 was tested on Musca domestica (house flies). A Dimethoate composition similar to this in which Antarox L-64 was replaced by Pluronic L44 NF was included in the Musca domestica test. A commercial cyclohexanon based Dimethoate 400 g/l EC was applied as reference in the test.

The Musca domestica contact test was done by exposing house flies to glazed tiles on which the three Dimethoate compositions had been sprayed at different concentrations. After 4 h the flies were transferred to Dimethoate free beakers and the mortality was recorded after 48 h.

The results are tabulated below.

TABLE 3

| | Dimethoate | Dimethoate 31% | Dimethoate 31% |
|---|---|---|---|
| | 400 g/l | Antarox L-64 | Pluronic L44 NF |
| | Commercial EC | EC | EC |
| LD50 (g ai/ha) | 4.0 | 3.1 | 3.4 |
| Musca | | | |
| domestica | | | |

According to the results in table 3, the two Dimethoate EO/PO block co-polymer based Dimethoate compositions were at least on par with the commercial EC formulation if not slightly better.

The three compositions mentioned in table 3 were tested on Dysdercus cingulatus nymphs in the 5^{th} development stage. The three compositions were sprayed at cotton leaves at different concentrations and the nymphs were placed on the leaves in petri dishes for 72 h. The mortality was recorded. The two EO/PO block copolymer based Dimethoate compositions were on par with the commercial EC formulation in this test on Dysdercus cingulatus nymphs.

The three compositions listed in table 3 were tested for phytotoxicity in a greenhouse trial. Tomato and cucumber plants were applied. Damage on the leaves, i.e. appearance of necrotic areas on the leaves, was recorded 3 and 7 days after application of the compositions. The dose rates applied were 100, 300, 1000, and 3000 g ai per ha. The volume sprayed was 400 l/ha. The commercial Dimethoate 400 g/l EC and the two Dimethoate compositions based on EO/PO block copolymers gave the same degree of phytotoxicity on both tomato and cucumber plants.

### EXAMPLE 8

The Dimethoate compositions listed in table 4 were prepared. The compositions were low-viscosity solutions which were easily diluted in water to spraying concentrations.

TABLE 4

| | Composition | | | | |
|---|---|---|---|---|---|
| | I | II | III | IV | |
| | % w/w | % w/w | % w/w | % w/w | Reference |
| Dimethoate | 38.3 | 38.3 | 38.3 | 38.3 | Commercial |
| Synperonic PE L/64 | 38 | 38 | | | Dimethoate |
| Synperonic PE L/44 | | | 38 | 38 | 400 g/l |
| Cyclohexanon | 19 | | 19 | | EC |
| Gamma- | | 19 | | 19 | |
| butyrolactone | | | | | |
| Acetic acid | 4.7 | 4.7 | 4.7 | 4.7 | |
| anhydride | | | | | |
| LD50 (g ai/ha) | 7.6 | 12.1 | 15.6 | 11.3 | 18.6 |
| Dysdercus | | | | | |
| cingulatus | | | | | |
| nymphs | | | | | |

The compositions listed in table 4 were tested on Dysdercus cingulatus nymphs being in the 5^{th} development stage. The test procedure was as described in example 7. According to the LD50 values in table 4, the compositions containing the EO/PO block copolymers, Synperonic PE L/64 or Synperonic PE L/44, had higher or slightly higher activity than the commercial Dimethoate 400 g/l EC.

The compositions in table 4 were also tested on Musca domestica applying the procedure described in example 8. The compositions I, II, III and IV were all on par with the commercial Dimethoate 400 g/l EC in this bio-efficacy test.

In a Spodoptera exigua larvae eating test done on cotton leaves in petri dishes the compositions I, II, III and IV were as active as the commercial Dimethoate 400 g/l EC formulation.

### EXAMPLE 9

The compositions listed in table 5 were produced.

TABLE 5

| | Composition | | |
|---|---|---|---|
| | I | II | III |
| Dimethoate tech | 32% w/w | 32% w/w | 32% w/w |
| Breox 50A 50 | 45% w/w | | |
| Breox 50A 140 | | 45% w/w | |
| Breox 50A 225 | | | 45% w/w |
| Cyclohexanone | 19% w/w | 19% w/w | 19% w/w |
| Acetic acid | 4% w/w | 4% w/w | 4% w/w |
| anhydride | | | |
| Dimethoate conc. | 30.6% w/w | 30.8% w/w | 30.2% w/w |
| before and | 30.1% w/w | 30.2% w/w | 29.6% w/w |
| after storage for 14 | | | |
| days at 54° C. | | | |
| Isodimethoate conc. | 0.029% w/w | 0.029% w/w | 0.020% w/w |
| before and after | 0.31% w/w | 0.18% w/w | 0.099% w/w |
| storage for 14 days | | | |
| at 54° C. | | | |
| Cold stable down to | 5° C. | 5° C. | 5° C. |

According to the results in table 5, the compositions I, II and III were chemically stable and they were cold stable down to at least 5° C.

The bio-efficacy of the compositions I, II and III were measured on Dysdercus cingulatus nymphs being in the 5^{th} development stage and on Musca domestica. In both tests the compostions were at least on par with a commercial Dimethoate 400 g/l EC. Likewise the three compositions I, II and III were on par with the commercial EC with regard to phytotoxicity on tomato and cucumber plants.

### EXAMPLE 10

A composition consisted of Dimethoate technical 36.5% w/w, minimum purity 96% w/w, cyclohexanone 19% w/w, a random copolymer of EO/PO, molecular weight 2500 (Sigma-Aldrich product no. 438197) 40.5% w/w and acetic acid anhydride 4% w/w. The composition was cold stable down to at least 5° C. The concentration of Dimethoate before and after storage for 14 days at 54° C. was 35.8% w/w and 34.4% w/w, respectively.

### EXAMPLE 11

The compositions listed in table 6 were prepared. The compositions were low viscosity liquids.

TABLE 6

| | Composition | | | | |
|---|---|---|---|---|---|
| | I | II | III | IV | V |
| Dimethoate tech | 40 | 36 | 34 | 34 | 34 |
| Agnique E-D 0001 | 37 | 41 | | | |
| Pluriol A 2000 PE | | | 43 | | |
| Pluriol A 2600 PE | | | | 43 | |
| Pluriol A 4000 PE | | | | | 43 |
| Cyclohexanone | 19 | 19 | 19 | 19 | 19 |
| Acetic acid | 4 | 4 | 4 | 4 | 4 |
| anhydride | | | | | |

Both in a Musca domestica test on tiles and in a test on Dysdercus cingulatus nymphs in the 5^{th} development stage, composition I from table 6 was at least as active as a commercial Dimethoate 400 g/l EC. Composition II, table 6, was stored for 14 days at 54° C. The dimethoate concentration before and after storage was 34.7% w/w and 34.0% w/w, respectively. The isodimethoate concentration in composition II before and after storage was 0.035% w/w and 0.36% w/w.

1. A formulation comprising:
a) dimethoate; and
b) a solvent chosen among liquids comprised of a compound having a ethylenglycol-propylenglycol co-polymeric chain as well as mixtures thereof.

2. The formulation according to claim 1, wherein the solvent is chosen among random co-polymer compounds comprised of ethylene oxide (EO) and propylene oxide (PO) units.

3. The formulation according to claim 1, wherein the solvent is chosen among non-random polymer compounds comprised of blocks of ethylene oxide (EO) and propylene oxide (PO) units.

4. The formulation according to claim 1, wherein solvent compound(s) is(are) end-capped.

5. The formulation according to claim 4, wherein the solvent compound(s) is(are) end-capped with group(s) selected among C₁-C₄ alkyl, C₁-C₄ alkyl-CO, and derivatives thereof.

6. The formulation according to claim 1, wherein the solvent is chosen among polymers of the formula (Ia), (Ib), (Ic), (Id).
R₁O—(C₂H₄O)ₚ—(C₃H₆O)_{q}—R₂ (Ia)
R₁O—(C₃H₆O)ₚ—(C₂H₄O)_{q}—R₂ (Ib)
R₁O—(C₂H₄O)ₚ—(C₃H₆O)_{q}—(C₂H₄O)ᵣ—R₂ (Ic)
R₁O—(C₃H₆O)ₚ—(C₂H₄O)_{q}—(C₃H₆O)ᵣ—R₂ (Id)
where p, q, r independently of one another represent an integer of 2 or more and R₁, R₂ independently of one another are hydrogen, C₁-C₄ alkyl, C₁-C₄ alkyl-CO, or derivatives thereof suitable for end-capping.

7. The formulation according to claim 6, wherein p, q, r independently of one another represent an integer of 5 or more.

8. The formulation according to claim 6, wherein p, q, r independently of one another represent an integer of 10 or more.

9. The formulation according to claim 6, wherein p, q, r independently of one another represent an integer of 300 or less.

10. The formulation according to claim 6, wherein p, q, r independently of one another represent an integer of 200 or less.

11. The formulation according to claim 6, wherein p, q, r independently of one another represent an integer of 150 or less.

12. The formulation according to claim 1, wherein the ratio of solvent b) to Dimethoate is 1 part of solvent b) to 4 parts or less of Dimethoate.

13. The formulation according to claim 1, wherein the ratio of solvent b) to Dimethoate is 1 part of solvent b) to 2 parts or less of Dimethoate.

14. The formulation according to claim 1, wherein the ratio of solvent b) to Dimethoate is 1 part of solvent b) to 1.5 parts or less of Dimethoate.

15. The formulation according to claim 1, wherein the ratio of solvent b) to Dimethoate is 1 part of solvent b) to 1.2 parts or less of Dimethoate.

16. The formulation according to claim 1, wherein the ratio of solvent b) to Dimethoate is 1 part of solvent b) to 1.1 parts or less of Dimethoate.

17. The formulation according to claim 1, wherein the ratio of solvent b) to Dimethoate is 1 part or more of solvent b) to 5 parts of Dimethoate.

18. The formulation according to claim 1, wherein the ratio of solvent b) to Dimethoate is 1 part or more of solvent b) to 4 parts of Dimethoate.

19. The formulation according to claim 1, wherein the ratio of solvent b) to Dimethoate is 1 part or more of solvent b) to 3 parts of Dimethoate.

20. The formulation according to claim 1, wherein the ratio of solvent b) to Dimethoate is 1 part or more of solvent b) to 2.5 parts of Dimethoate.

21. The formulation according claim 1, wherein the ratio of solvent b) to Dimethoate is 1 part or more of solvent b) to 2 parts of Dimethoate.

22. The formulation according to claim 1, wherein the amount of solvent b) is higher than 20% by weight, based on the total weight of the formulation.

23. The formulation according to claim 1, wherein the amount of solvent b) is higher than 30% by weight, based on the total weight of the formulation.

24. The formulation according to claim 1, wherein the amount of solvent b) is higher than 35% by weight, based on the total weight of the formulation.

25. The formulation according to claim 1, wherein the amount of solvent b) is less than 95% by weight, based on the total weight of the formulation.

26. The formulation according to claim 1, wherein the amount of solvent b) is less than 85% by weight, based on the total weight of the formulation.

27. The formulation according to claim 1, wherein the amount of solvent b) is less than 75% by weight, based on the total weight of the formulation.

28. The formulation according to claim 1, wherein the amount of solvent b) is less than 55% by weight, based on the total weight of the formulation.

29. A formulation according to claim 1, further comprising a co-solvent.

30. A formulation according to claim 29, wherein the co-solvent is selected among the group consisting of mineral oils; aliphatic, cyclic, and aromatic carbon hydride compounds; aliphatic, cyclic and aromatic alcohols; gamma-butyrolactone; cyclohexanone; and highly polar compounds.

31. A formulation according to claim 29, wherein the ratio of solvent b) to the co-solvent is 1 part of solvent b) to 1.0 part or less of the co-solvent.

32. A formulation according to claim 29, wherein the ratio of solvent b) to the co-solvent is 1 part of solvent b) to 0.8 parts or less of the co-solvent.

33. A formulation according to claim 29, wherein the ratio of solvent b) to the co-solvent is 1 part of solvent b) to 0.7 parts or less of the co-solvent.

34. A formulation according to claim 29, wherein the ratio of solvent b) to the co-solvent is 1 part of solvent b) to 0.6 parts or less of the co-solvent.

35. A formulation according to claim 29, wherein the ratio of solvent b) to co-solvent is 1 part of the solvent b) to 0.05 parts or more of co-solvent.

36. A formulation according to claim 29, wherein the ratio of solvent b) to co-solvent is 1 part of the solvent b) to 0.15 parts or more of co-solvent.

37. A formulation according claim 29, wherein the ratio of solvent b) to co-solvent is 1 part of the solvent b) to 0.30 parts or more of co-solvent.

38. A formulation according to claim 1, further comprising one or more surfactants and/or one or more auxiliaries selected among pH-adjusters, thickeners, antifreeze agents, preservatives, antifoaming and defoamer agents, spreading agents, stickers, UV-protectants, stabilizers, and additional insecticides.

39. A formulation according to claim 38, wherein the stabilizer is chosen among anhydrides.

40. A method for the control of insects, said method comprise applying a formulation according to claim 1 to insects; or to plants, plant seeds, soil, surfaces and the like infested with insects or likely to be occupied by insects.
